(19) United States
(12) Patent Application Publication
(10) Pub. No.: US 2013/0147086 A1
(43) Pub. Date: Jun. 13, 2013

(54) Extrusion of PVDC

(71) Applicant: John Gordon Nelson, Pauls Valley, OK (US)

(72) Inventor: John Gordon Nelson, Pauls Valley, OK (US)

(73) Assignee: John Gordon Nelson, Pauls Valley, OK (US)

(21) Appl. No.: 13/694,655

(22) Filed: Dec. 26, 2012

(51) Int. Cl. B29C 47/00

(52) U.S. Cl. CPC B29C 47/0004
USPC 264/176.1

(57) ABSTRACT

Adding a small amount [trace] of finely ground polyethylene to pvdc prior to extrusion, protects the pvdc from decomposing to hydrogen and carbon. This enables longer extruder run times, lower waste, and a higher quality product.

Polyvinylidene chloride (pvdc) is very difficult to extrude. It decomposes into hydrogen chloride and elemental carbon. The decomposition is catalyzed by contact with metal. During extrusion it is in contact with the extruder screw, the extruder barrel and the die. It is common practice to start with a clean extruder and die. Polyethylene is extruded first to coat thoroughly the metal parts of the extruder and die. Extrusion of pvdc follows the polyethylene. The pvdc soon scours the polyethylene coating and gains metal contact. Decomposition of the pvdc starts with metal contact. A steadily increasing number of black specks of carbon occur in the product until the extruder is stopped for cleaning. This, of course, is an inefficient process.

This invention encapsulates the pvdc in a thin coating of polyethylene to prevent the pvdc from metal contact. This produces a better product, free of black specks. The extruder is able to run for weeks or months without having to be stopped for cleaning. The result is lower waste, higher production and a lower cost of production.

To encapsulate the pvdc finely ground polyethylene is intimately mixed with the pvdc before extrusion. During extrusion the polyethylene melts before the pvdv. Polyethylene is insoluble in pvdc. The small droplets of polyethylene are squeezed out of the pvdc towards the extruder walls or screw. A small amount (trace) of polyethylene encapsulates all of the pvdc. This prevents contact between the pvdc and the metal. This prevents metal catalyzed decomposion of the pvdc

The time that extruders are able to run is extended from days to months. The extruder barrel and screw are not coated with carbon black from the decomposing pvdc. Instead they are coated with a very thin layer of polyethylene. This results in a tremendous decrease in waste. Shutdowns and startups create waste.

The quality of the product is improved. Black specks of carbon within the product lower the product quality.

In summary this invention improves the quality of the product. It reduces waste. It increases the run time or the output of the individual extruder.

### SUMMARY

Adding a small amount [trace] of finely ground polyethylene to pvdc prior to extrusion protects the pvdc from decomposing to hydrogen chloride and carbon. This enables longer extruder run times, lower waste and a higher quality product.

1. The time that pvdc extruders are able to run without being stopped for cleaning is extended from days to weeks or months.

2. The amount of waste generated is reduced.

3. The quality of the product is improved by the decrease in the black specks of carbon in the product.
